(19) United States
(12) Patent Application Publication
(10) Pub. No.: US 2026/0039997 A1
(43) Pub. Date: Feb. 5, 2026

(54) Directional Loudspeaker

(71) Applicant: Dutch&Dutch B.V., Capelle aan den IJssel (NL)

(72) Inventor: Martijn Mensink, Almelo (NL)

(21) Appl. No.: 19/283,610

(22) Filed: Jul. 29, 2025

(30) Foreign Application Priority Data
Jul. 30, 2024 (NL) 2038359

(51) Int. Cl. H04R 1/32

(52) U.S. Cl. CPC H04R 1/323

(57) ABSTRACT

A loudspeaker with directional effect along a main axis extending from a front side of the loudspeaker, including a housing; at least one sound source configured to produce sound waves substantially in a first frequency range, wherein the sound waves include front waves on the front side of the sound source and include rear waves on the rear side of the sound source, and an acoustic horn having a neck acoustically coupled to the front waves and a directional effect along the main axis for front waves lying in a second frequency range, and an attenuation axis lying at an angle relative to the main axis, wherein the loudspeaker obtains for front and rear waves lying in a third frequency range a directional effect along the main axis for front waves in the third frequency range by destructive interference between the respective rear and front waves around the attenuation axis.

### CROSS-REFERENCE TO RELATED APPLICATION

This application claims priority to The Netherlands Patent Application No. 2038359 filed Jul. 30, 2024, the disclosure of which is hereby incorporated by reference in its entirety.

### BACKGROUND OF THE INVENTION

### Field of the Invention

The present invention relates to a loudspeaker for use in the audio spectrum with directional effect along a main axis.

### Description of Related Art

Sound waves in the audio spectrum propagate from loudspeakers in different directions. This propagation varies depending on the direction in which the sound waves are emitted and also depends on the frequency of the sound waves. This variation is described by the directivity of a loudspeaker.

In a directional loudspeaker the directivity is aimed as much as possible in the direction of a main axis of the loudspeaker. At higher frequencies, wherein the wavelength is smaller than the dimension of the emitter, such as a waveguide, the sound waves can be bundled in relatively simple manner for the purpose of obtaining directional effect. At lower frequencies, the wavelength will quickly become so great that the directional effect can no longer be reasonably obtained by bundling. This is because, at a frequency of 0.7 kHz, there is already a wavelength of λ=0.5 m, whereby a directional loudspeaker on the basis of bundling would have to be very large.

EP3018915A1 describes a directional loudspeaker for use in the midfrequency range of the audio spectrum. The midfrequency range according to this publication is the range at which the wavelength is greater than the smallest main dimension of the front panel of the loudspeaker and is smaller than half the greatest main dimension of the front panel of the loudspeaker, such as for instance 300 Hz to 1.8 kHz. For this midfrequency range the damping on the rear side is optimized in order to obtain more than 15 dB of damping, resulting in a good directivity in the midfrequency range.

A drawback of the known directional loudspeaker is that, when a greater reproduction range is desired, the directivity is difficult to maintain in the higher frequencies.

### SUMMARY OF THE INVENTION

It is now an object of the invention to reduce or even wholly obviate at least one of the above stated drawbacks.

This object is achieved according to an embodiment of the invention by providing a loudspeaker for use in the audio spectrum with directional effect along a main axis extending from a front side of the loudspeaker, including:
a housing
at least one sound source arranged in the housing, which sound source is configured to produce sound waves substantially in a first frequency range lying between a lower frequency and an upper frequency, wherein the produced sound waves include front waves on the front side of the sound source and include rear waves on the rear side of the sound source, and
an acoustic horn which extends between a neck and a mouth along a horn axis, which neck is acoustically coupled to the front waves and which horn has a directional effect along the main axis for front waves lying in a second frequency range and having a frequency higher than a midfrequency lying between the lower and upper frequency,
wherein the loudspeaker includes an attenuation axis lying at an angle relative to, preferably opposite the main axis, and is configured to obtain for front waves and rear waves lying in a third frequency range and having a frequency lower than the midfrequency, and by means of a phase shift between the respective rear waves and front waves obtained by means of a difference between a rear propagation time to the attenuation axis for rear waves and a front propagation time to the attenuation axis for front waves, a directional effect along the main axis for front waves with a frequency in the third frequency range by destructive interference between the respective rear waves and front waves around the attenuation axis.

A loudspeaker according to an embodiment of the invention thus obtains directivity over a wide frequency range, so a range wherein there can for instance be wavelengths smaller than the smallest main dimension of the front side of the loudspeaker and wavelengths greater than half the greatest main dimension of the front side of the loudspeaker, by bringing about directional effect along the main axis for frequencies in the second frequency range by means of horn effect and bringing about directional effect for frequencies in the third frequency range by destructive interference, around an attenuation axis, between front waves and rear waves.

The sound source can for instance be a known acoustic player, such as for instance an electrodynamic loudspeaker, wherein a membrane or cone is set into movement so as to generate sound waves in the surrounding area. The front waves result on the one side or front side of the membrane, and the rear waves corresponding therewith on the other side or rear side of the membrane. The sound source can alternatively also include a separate acoustic player for the front waves and the rear waves.

The front waves of the sound source are radiated substantially or wholly via the acoustic horn. The acoustic horn has here directional effect along the main axis for front waves with a frequency in the second frequency range. The main axis of the loudspeaker is the imaginary line running straight ahead from the centre of the side of the loudspeaker which is oriented toward the listening position in use, since this is the direction in which the loudspeaker radiates the most sound and in which the audio performance is therefore often best.

An acoustic horn is characterized by a gradually enlarging opening between the neck and the mouth. This increases the efficiency of the sound source by a gradual transition from the high acoustic impedance of the sound source to the lower impedance of the ambient air. A directional effect further occurs for front waves having a wavelength smaller than the greatest main dimension of the mouth. Using a horn for front waves and the second frequency range enables better efficiency and directivity to be obtained for this frequency range.

Where the directional effect of the acoustic horn begins to decrease at lower frequencies, the directional effect of the loudspeaker is continued according to the invention by making use for the lower frequencies of destructive interference of the front waves and the rear waves around one or more attenuation axes of the loudspeaker. Similarly to the main axis, an attenuation axis is an imaginary line in a direction in which the loudspeaker radiates the least amount of sound and in which the destructive interference is thus optimal. An attenuation axis preferably lies substantially opposite the main axis, preferably between 110-250° relative thereto, more preferably 180° relative thereto. It is however also possible to opt to design the loudspeaker so that a different angle relative to the main axis is obtained, for instance depending on features of the space where the loudspeaker is set up. There can also be a plurality of attenuation axes, wherein there are multiple directions in which a minimal radiation takes place. The direction of an attenuation axis can also have a different direction in a determined frequency range than in another frequency range. In order to obtain the most complete destructive interference possible, the front waves and the rear waves must cancel each other out around an attenuation axis of the loudspeaker in order to achieve full interference. This means that the sound waves must be 180° out of phase. They must further have substantially the same amplitude at the position where the front waves and the rear waves meet. In sound sources that make use of a membrane such as a cone the rear waves are at the position of the sound source already opposite in phase to the front waves, since the rear waves are generated by the rear side of the membrane of the acoustic converter. The propagation time of the front waves to an attenuation axis of the loudspeaker is however usually longer than the preparation time of the rear waves to this attenuation axis, since the path length of the transmission path differs for the two sound waves depending on the design and dimensioning of the housing. Besides the path length, the propagation speed of the sound waves is also important. According to the invention, by means of a difference between the rear propagation time to an attenuation axis for rear waves and the front propagation time to this attenuation axis for front waves the necessary phase shift between the respective rear waves and front waves is obtained. The characteristic of the rear waves must therefore correspond around this attenuation axis as far as possible with the front waves, which do not radiate directionally and thus also reach the attenuation axis in question.

A loudspeaker according to an embodiment of the invention thus combines for a sound source the directional effect by destructive interference around an attenuation axis in the lower frequencies, the third frequency range, and the directional effect by horn effect in the higher frequencies, the second frequency range.

For the directional effect in the third frequency range it is neither necessary nor desirable according to the invention to apply an additional sound source which actively spreads a damping rear wave, since the rear waves of the sound source are used for the destructive interference.

The directivity in the third frequency range obtained by the destructive interference can for instance be a cardioid, supercardioid or hypercardioid radiation pattern.

In an embodiment of a loudspeaker according to the invention the rear propagation time is increased by application of at least one of the measures selected from an acoustically resistive material and an extended transmission path to the attenuation axis for rear waves.

Guiding the rear waves through an acoustically resistive material, in which the propagation speed of sound is lower than the propagation speed of sound in air, increases the rear propagation time. An acoustically resistive material can also be used here to affect the characteristics of the rear waves in order to obtain the greatest possible similarity in amplitude and waveform between the front waves and the rear waves around the attenuation axis, in addition to the relative phase shift relative to the front waves. Alternatively or additionally, the transmission path for rear waves to the attenuation axis can also be extended.

In yet another embodiment of a loudspeaker according to the invention the housing defines an acoustic chamber and the sound source is arranged in a loudspeaker opening provided in a wall of the chamber, wherein the rear waves debouch into the chamber.

Applying an acoustic chamber into which the rear waves debouch enables the characteristic of the rear waves to be controlled further. The radiation of the rear waves can be controlled by means of the chamber.

In an embodiment of a loudspeaker an acoustically resistive material is here preferably arranged in the chamber.

By applying an acoustically resistive material in the chamber the rear propagation time can on one hand be increased, but the frequency characteristic and amplitude of the rear waves can on the other hand also be tuned.

Also according to the invention is an embodiment of a loudspeaker wherein the chamber also includes at least one opening through which at least a part of the rear waves can leave the chamber. The volume and the geometry of the chamber are here important parameters affecting the characteristic of the rear waves. The position and the geometry of the at least one opening are preferably chosen here such that the rear waves leaving the chamber correspond with the front waves close to the attenuation axis as far as possible in amplitude and spectrum close to the attenuation axis.

The air volume bounded by the acoustic chamber, and preferably damped by means of an acoustically resistive material arranged therein, and the at least one opening form an acoustic low-pass filter which results in a phase shift of the rear waves.

By means of one or more openings in the chamber through which rear waves can leave the chamber the rear waves can be further tuned to the front waves. The placing, geometry and dimensioning of an opening or of a number of openings can affect the pass characteristic, whereby a determined frequency band is present to greater or lesser extent in the rear waves that reach the attenuation axis. The specific placing depends greatly on the remaining characteristics of the loudspeaker, such as for instance the frequency response of the sound source, but also the applicable lower and upper frequency.

In another embodiment of a loudspeaker according to the invention a main dimension of the mouth measured at right angles to the horn axis, preferably a greatest main dimension of the mouth, corresponds with the wavelength of the midfrequency.

Because the directional effect of an acoustic horn decreases greatly when the wavelength corresponds with the mouth opening or at least a main dimension thereof, the midfrequency is preferably chosen corresponding therewith. Below the midfrequency the directional effect is then obtained by the interference between the rear waves and the front waves.

In a preferred embodiment of a loudspeaker according to the invention the neck of the horn is acoustically coupled to the front waves via a compression chamber, wherein the front waves coming from the sound source debouch into the compression chamber.

By applying a compression chamber together with the horn some resistance is given to the generator of the sound waves of the sound source, whereby the excursion thereof can remain better controlled and a higher efficiency of the sound production can be obtained. A compression chamber is moreover also a form of an acoustic low-pass filter.

Another embodiment of a loudspeaker according to the invention is a loudspeaker wherein the directivity in the second and the third frequency range substantially correspond.

Undesirable reflections in a space in which the loudspeaker is set up are hereby limited as far as possible over the whole frequency range of the loudspeaker. The uniform character also makes the relative placement relative to for instance a listening position simpler.

Another preferred embodiment of a loudspeaker according to the invention is a loudspeaker wherein the front waves are horn-directed in the second frequency range and are directed by a cardioid radiation in the third frequency range.

In yet another embodiment of a loudspeaker according to the invention the midfrequency lies in the 0.9-1.2 kHz range.

Around this midfrequency a dimensioning of the loudspeaker is possible which does not prevent application in for instance recording studios or homes. At a frequency of 0.9 kHz there is a wavelength of about 0.4 m. A horn with a corresponding main dimension in this range can still be applied in a loudspeaker.

### BRIEF DESCRIPTION OF THE DRAWINGS

The terms Fig., Figs., Figure, and Figures are used interchangeably in the specification to refer to the corresponding figures in the drawings.

These and other features of the invention are further elucidated with reference to the accompanying figures.

FIG. 1 shows a schematic representation of a first embodiment of a directional loudspeaker according to the invention.

FIG. 2 shows a schematic representation of a second embodiment of a directional loudspeaker according to the invention.

FIG. 3 shows a simulated amplitude response of the horn-directed front waves of a directional loudspeaker according to the invention.

FIG. 4 shows a simulated amplitude response of the front waves, the acoustically filtered rear waves and the combined amplitude response thereof.

FIG. 5 shows a simulated amplitude response of a directional loudspeaker according to the invention on the main axis and an attenuation axis.

### DETAILED DESCRIPTION

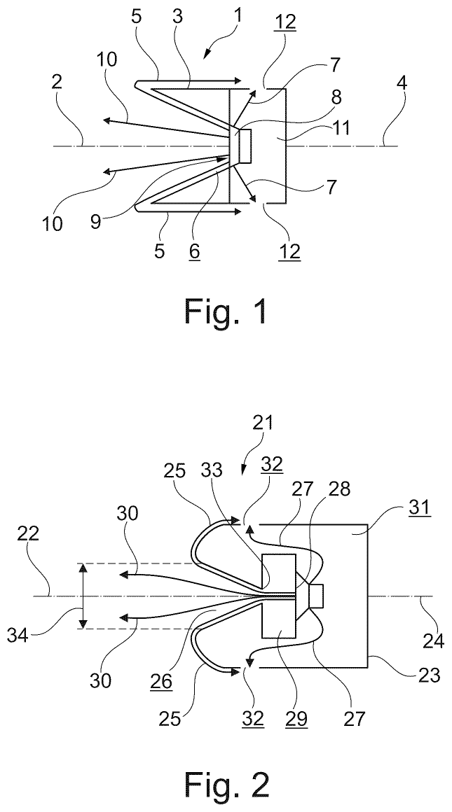

FIG. 1 shows a schematic representation of a first embodiment of a directional loudspeaker 1 according to the invention. The main axis 2, along which the radiation is substantially directed, extends from a front side of the loudspeaker 1. Shown on the rear side of loudspeaker 1 lying opposite the main axis 2 is the attenuation axis 4. At the attenuation axis 4 there is a minimum in the sound pressure level, since the front waves 5 which are not radiated directionally by the acoustic horn 6 interfere destructively there with the rear waves 7. The sound source 8 is arranged in the housing 3. The front side 9 of the sound source 8 radiates the front waves 5, 10 into the horn 6 and on the rear side of sound source 8 the rear waves 7 are radiated into the acoustic chamber 11 in opposite phase. The chamber 11 is provided with openings 12. For the front waves 10 with a frequency in the second frequency range the horn 6 has a directional effect along the main axis 2. For the front waves 5 with a frequency in the third frequency range the horn 6 has no directional effect, or a greatly reduced directional effect. The front waves 5 can hereby also propagate toward the attenuation axis 4.

It is clearly visible in FIG. 1 that the length of the transmission path up to the point wherein the front waves 5 in the third frequency range and the rear waves 7 meet, in the shown example located symmetrically relative to the attenuation axis 4, is much shorter for the rear waves 7. In order to increase the rear propagation time for the rear waves 7 an acoustically resistive material is provided in the chamber 11. The phase shift required for destructive interference is realized thereby.

FIG. 2 shows a schematic representation of a second embodiment of a directional loudspeaker 21 according to the invention. Extending once again from a front side of the loudspeaker 21 is the main axis 22, and shown lying opposite is the attenuation axis 24. The sound source 28 is arranged in the housing 23. The sound source 28 radiates the front waves 25, 30 into a compression chamber 29. The neck 33 of the horn 26 is connected to the compression chamber 29. The rear waves 27 radiate via the acoustic chamber 31 out through the openings 32 arranged therein. The openings 32 are arranged close to the mouth of the horn 26, whereby the rear propagation time corresponds much more closely to the front propagation time. In order to obtain the desired phase shift and to tune the characteristic of the rear waves 27, the chamber 31 can be provided with acoustically resistive material. For the front waves 30 with a frequency in the second frequency range the horn 26 has a directional effect along the main axis 22. For the front waves 25 with a frequency in the third frequency range the horn 26 has no directional effect, or a greatly reduced directional effect. The front waves 25 can hereby also propagate toward the attenuation axis 24. The wavelength of the midfrequency corresponds with the main dimension 34 of the mouth of the horn 26.

In an embodiment of a loudspeaker according to the invention the main dimension 34 of horn 26 is 0.30 m. The midfrequency is then about 1.1 kHz. The horn 26 has a depth of 0.15 m. The depth of a horn 26 is the distance between the mouth and the neck 32. The directional effect of the described horn 26 decreases rapidly below 1.1 kHz. The sound source 28 is embodied as an electrodynamic loudspeaker configured to produce sound waves substantially between a lower frequency of 0.1 kHz and an upper frequency of 8 KHz. The sound source 28 is based on a membrane in the form of a cone, whereby at the sound source 28 the front waves 25, 30 are in counter-phase with the rear waves 27. The second frequency range thus lies between 1.1-8 kHz and the third frequency range between 0.1-1.1 kHz. In the second frequency range there is horn-directed radiation. In the third frequency range there is cardioid radiation. The volume of the chamber 31 is about 0.7 l. With an embodiment as described a greatly improved directivity could already be obtained in a simple test arrangement with a directivity index of ˜5-8 dB, both above and below the midfrequency.

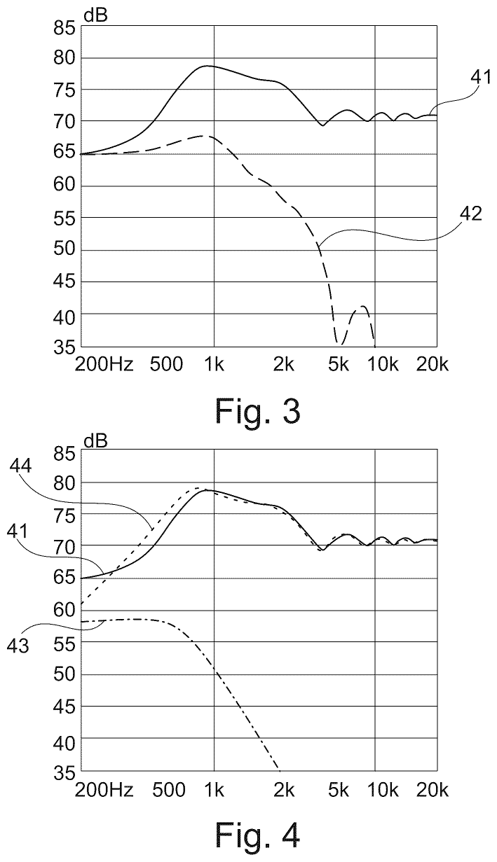

FIG. 3 shows a simulated amplitude response of the front waves of a directional loudspeaker according to the invention. The amplitude response is based on a simulation of a directional loudspeaker according to the invention with a main dimension of the horn of 0.30 m, in which a single 4″ midrange driver is arranged. In the figure an amplitude response 41 measured on the main axis, i.e. 0°, is shown, as is an amplitude response 42 measured on the attenuation axis lying opposite, i.e. at 180°. It can be clearly inferred from the figure that the horn effect results in a very great directional effect at high frequencies, which begins to decrease gradually below 5 kHz. Below 1 kHz an accelerated decrease of the directional effect occurs. This accelerated decrease of the directional effect occurs around the midfrequency, wherein the wavelength corresponds with the main dimension of the mouth of the horn. At around 150 Hz the directional effect has been reduced to nothing.

FIG. 4 shows simulated amplitude responses. The figure shows the amplitude response 41 of the front waves measured on the main axis and the amplitude response 43 of the acoustically filtered rear waves measured on the main axis. For the simulation the loudspeaker is here on the rear side provided on both sides with an opening for the rear waves. The combined amplitude response 44 shows the combination of the front waves and the rear waves. Visible here below 250 Hz is an attenuation, in that destructive interference takes place in this range. Between 250 Hz and 900 Hz the combined amplitude response 44 is louder than the front waves only, since the rear waves interfere constructively with the front waves. In this transition range, which could for instance be referred to as fourth frequency range or midfrequency range, the directionality is thus intensified by constructive interference.

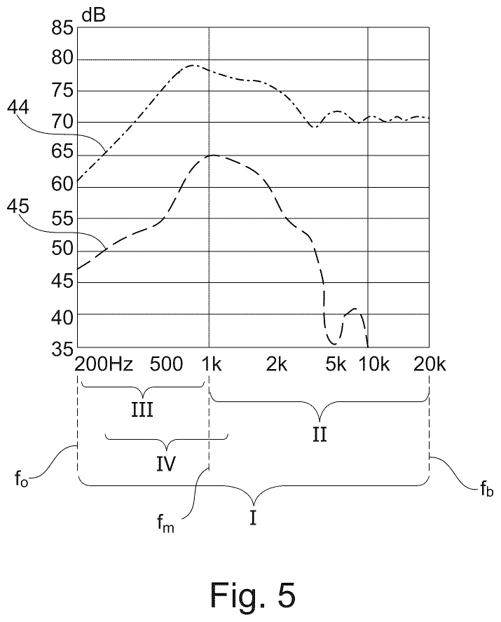

FIG. 5 shows another simulated amplitude response 44 measured on the main axis of a directional loudspeaker according to the invention, and a simulated amplitude response 45 measured on the attenuation axis lying at 180° relative to the main axis. The figure clearly shows that a greatly improved directional effect along the main axis is obtained for front waves with a frequency in the third frequency range, so below the midfrequency of 1 Khz for the simulated loudspeaker according to the invention, by destructive interference between the rear waves and front waves around the attenuation axis.

FIG. 5 further also shows an indication of the respective designated frequencies and frequency ranges. The whole figure covers frequencies in the audio spectrum. The first frequency range I lies between a lower frequency fo and an upper frequency fb. The midfrequency fm corresponds with the frequency at which the wavelength approximately corresponds with the greatest main dimension of the mouth of the horn used. Owing to horn effect, there is directional effect along the main axis for front waves lying in the second frequency range II. These have a frequency higher than the midfrequency fm. Front waves with a frequency in the third frequency range III are attenuated by destructive interference between the respective rear waves and front waves around the attenuation axis. The fourth frequency range IV as stated with reference to the description of FIG. 4 is also designated, and will include or border on the midfrequency fm in the majority of cases.

1. A loudspeaker for use in the audio spectrum with directional effect along a main axis extending from a front side of the loudspeaker, comprising:
a housing,
at least one sound source arranged in the housing, which sound source is configured to produce sound waves substantially in a first frequency range lying between a lower frequency and an upper frequency, wherein the produced sound waves comprise front waves on the front side of the sound source and comprise rear waves on the rear side of the sound source, and
an acoustic horn which extends between a neck and a mouth along a horn axis, which neck is acoustically coupled to the front waves and which horn has a directional effect along the main axis for front waves lying in a second frequency range and having a frequency higher than a midfrequency lying between the lower and upper frequency,
wherein the loudspeaker comprises an attenuation axis lying at an angle relative to, preferably opposite the main axis, and is configured to obtain for front waves and rear waves lying in a third frequency range and having a frequency lower than the midfrequency, and by means of a phase shift between the respective rear waves and front waves obtained by means of a difference between a rear propagation time to the attenuation axis for rear waves and a front propagation time to the attenuation axis for front waves, a directional effect along the main axis for front waves with a frequency in the third frequency range by destructive interference between the respective rear waves and front waves around the attenuation axis.

2. The loudspeaker according to claim 1, wherein the rear propagation time is increased by application of at least one of the measures selected from an acoustically resistive material and an extended transmission path to the attenuation axis for rear waves.

3. The loudspeaker according to claim 1, wherein the housing defines an acoustic chamber and the sound source is arranged in a loudspeaker opening provided in a wall of the chamber, wherein the rear waves debouch into the chamber.

4. The loudspeaker according to claim 3, wherein an acoustically resistive material is arranged in the chamber.

5. The loudspeaker according to claim 3, wherein the chamber also comprises at least one opening through which at least a part of the rear waves can leave the chamber.

6. The loudspeaker according to claim 5, wherein the position and the geometry of the at least one opening are chosen such that the rear waves leaving the chamber correspond with the front waves close to the attenuation axis as far as possible in amplitude and spectrum close to the attenuation axis.

7. The loudspeaker according to claim 1, wherein a main dimension of the mouth measured at right angles to the horn axis, preferably a greatest main dimension of the mouth, corresponds with the wavelength of the midfrequency.

8. The loudspeaker according to claim 1, wherein the neck of the horn is acoustically coupled to the front waves via a compression chamber, wherein the front waves coming from the sound source debouch into the compression chamber.

9. The loudspeaker according to claim 1, wherein the directivity in the second and the third frequency range substantially correspond.

10. The loudspeaker according to claim 1, wherein the front waves are horn-directed in the second frequency range and are directed by a cardioid radiation in the third frequency range.

11. The loudspeaker according to claim 1, wherein the midfrequency lies in the 0.9-1.2 kHz range.
